(19) United States
(12) Patent Application Publication
(10) Pub. No.: US 2014/0355980 A1
(43) Pub. Date: Dec. 4, 2014

(54) OPTICAL COMMUNICATION APPARATUS AND CONTROL METHOD THEREOF

(71) Applicants: FUJITSU LIMITED, Kawasaki-shi (JP); FUJITSU TELECOM NETWORKS LIMITED, Kawasaki-shi (JP)

(72) Inventors: Yuichiro Sakane, Fukuoka (JP); Koji Matsunaga, Munakata (JP); Yasuo Tanaka, Fukuoka (JP); Tatsuya Toyozumi, Onojo (JP); Koji Bato, Fukuoka (JP); Wataru Kawasaki, Kawasaki (JP); Tatsuhiko Saito, Kawasaki (JP)

(73) Assignees: FUJITSU LIMITED, Kawasaki-shi (JP); FUJITSU TELECOM NETWORKS LIMITED, Kawasaki-shi (JP)

(21) Appl. No.: 14/294,363

(22) Filed: Jun. 3, 2014

(30) Foreign Application Priority Data
Jun. 4, 2013 (JP) 2013-118215

(51) Int. Cl. H04B 10/572; H04B 10/50

(52) U.S. Cl. CPC H04B 10/572; H04B 10/506
USPC 398/34

(57) ABSTRACT

An optical communication apparatus includes a variable resistor unit, a measurement unit, and a control unit. The variable resistor unit is arranged at a pre-stage of an electrical/optical conversion unit, which converts an electrical signal obtained by converting an input packet to an optical signal having a waveform corresponding to a potential difference between a positive phase component and a negative phase component of the electrical signal by using the potential difference. The variable resistor unit provides a resistor that varies a midpoint of potential of the positive phase component or the negative phase component. The measurement unit measures a ratio of a presence period, which is a period where the input packet is present, to a sum of the presence period and a non-presence period. The control unit controls a value of the resistor provided to the positive phase component or the negative phase component based on the ratio.

### CROSS-REFERENCE TO RELATED APPLICATION

This application is based upon and claims the benefit of priority of the prior Japanese Patent Application No. 2013-118215, filed on Jun. 4, 2013, the entire contents of which are incorporated herein by reference.

### FIELD

The embodiment discussed herein is directed to an optical communication apparatus and a control method thereof.

### BACKGROUND

In recent years, in the field of optical transmission, there has been a demand of conversion technique to convert electrical signals to optical signals at a high speed due to expansion of the internet and increase of information amount to be handled. A conversion technique using a differential Electrical/Optical (E/O) converter is generally known as a high-speed conversion technique.

In the conversion technique using a differential E/O converter, an E/O converter of a transmitting optical communication apparatus converts an electrical signal to an optical signal having a waveform corresponding to a potential difference between the positive phase component and the negative phase component of the electrical signal obtained by converting an input packet by using the potential difference. An input packet may be an IP packet or the like that is input through, for example, 10G Ethernet (registered trademark). Then, the optical signal converted by the transmitting optical communication apparatus is transmitted to a receiving optical communication apparatus, and an O/E convertor of the receiving optical communication apparatus converts the optical signal to an electrical signal. The receiving optical communication apparatus determines data based on the waveform of the electrical signal obtained by converting the optical signal. For example, the receiving optical communication apparatus determines that data is “1” when the waveform of the electrical signal obtained by converting the optical signal is larger than a predetermined area and determines that data is “0” when the waveform of the electrical signal is smaller than the predetermined area (Japanese Laid-open Patent Publication No. 2012-124731).

However, in the conventional technique, improvement of a signal waveform that is deteriorated due to presence/non-presence of input packets is not considered.

That is, in the conventional technique, impedance of a capacitor of AC coupling that allows a positive phase component and a negative phase component to be input to the E/O converter becomes near zero and the midpoints of the potential of the positive and negative components match in a period where input packets to be input to the transmitting optical communication apparatus are present. On the other hand, in a period where no input packet to be input to the transmitting optical communication apparatus is present, impedance of a capacitor of the AC coupling that allows the positive phase component and the negative phase component to be input to the E/O converter becomes infinitely large and the midpoints of the potential of positive and negative components to be input to the E/O converter are apart in opposite directions. A case where the input packets are IP packets input through 10G Ethernet is assumed as an example. In this case, in an Inter-Frame Gap (IFG) that is a time period between an IP packet and another IP packet where no IP packet is present, the midpoints of the potential of an positive phase component and the midpoint of the potential of a negative phase component to be input to the E/O converter are apart in opposite directions. The E/O converter converts an electrical signal to an optical signal having a waveform corresponding to a potential difference between the positive phase component and the negative phase component that are apart in opposite directions using the potential difference. Therefore, a waveform of an optical signal output from the E/O converter of the transmitting optical communication apparatus may be deteriorated. A deteriorated waveform of an optical signal output from the E/O converter of the transmitting optical communication apparatus makes it difficult for the receiving optical communication apparatus to determine whether a waveform of an electrical signal obtained by converting an optical signal is larger than a predetermined area. Thus, the receiving optical communication apparatus may wrongly determine data.

### SUMMARY

According to an aspect of an embodiment, an optical communication apparatus includes a variable resistor unit that is arranged at a pre-stage of an electrical/optical conversion unit, which converts an electrical signal obtained by converting an input packet to an optical signal having a waveform corresponding to a potential difference between a positive phase component and a negative phase component of the electrical signal by using the potential difference, and that provides, to the positive phase component or the negative phase component, a resistor that varies a midpoint of potential of the positive phase component or the negative phase component to be input to the electrical/optical conversion unit; a measurement unit that measures a ratio of a presence period, which is a period where the input packet is present, to a sum of the presence period and a non-presence period, which is a period other than the presence period; and a control unit that controls a value of the resistor provided by the variable resistor unit based on the ratio measured by the measurement unit in such a manner that the midpoint of the potential of the positive phase component and the midpoint of the potential of the negative phase component, which would be apart in opposite directions in the non-presence period, get closer to each other.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a whole configuration of a network including an optical packet transmitter according to the present embodiment;

FIG. 2 is a functional block diagram illustrating a configuration of the optical packet transmitter according to the present embodiment;

FIG. 3 is a drawing for describing a packet presence probability;

FIG. 4 is a drawing for describing relationship between the packet presence probability and behavior of a positive phase component and a negative phase component (part 1);

FIG. 5 is a drawing for describing relationship between the packet presence probability and behavior of a positive phase component and a negative phase component (part 2);

FIG. 6 is a drawing for describing relationship between the packet presence probability and behavior of a positive phase component and a negative phase component (part 3);

FIG. 7 is a diagram illustrating relationship between an eye pattern of electrical signals input to an E/O conversion unit and an eye pattern of optical signals output from the E/O conversion unit;

FIG. 8 is a diagram illustrating an example of a data structure of a resistance value storage unit in the present embodiment;

FIG. 9 is a diagram for describing resistance-value control processing for changing the resistance value of a variable resistor unit; and

FIG. 10 is a flowchart illustrating a process of the optical packet transmitter according to the present embodiment.

### DESCRIPTION OF EMBODIMENT

Preferred embodiment of the present invention will be explained with reference to accompanying drawings. In the embodiment provided below, there will be described an example where the optical communication apparatus disclosed in the present application is applied to an optical packet transmitter that transmits optical packets. This embodiment is not intended to limit the disclosed technique.

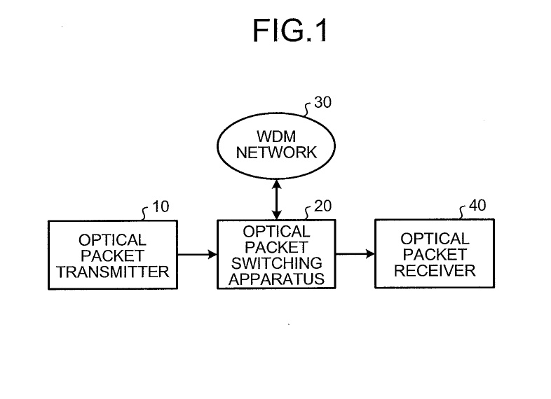

FIG. 1 is a diagram illustrating an example of a whole configuration of a network including an optical packet transmitter of the present embodiment. The network illustrated in FIG. 1 includes an optical packet transmitter 10, an optical packet switching apparatus 20, a Wavelength Division Multiplexing (WDM) network 30, and an optical packet receiver 40.

The optical packet transmitter 10 is a node device that converts, for example, an IP packet to an optical packet and transmits the optical packet. The optical packet switching apparatus 20 switches the optical packet transmitted from the optical packet transmitter 10 to transfer the optical packet to the WDM network 30 or the optical packet receiver 40. Configuration of the optical packet transmitter 10 will be described below.

The optical packet switching apparatus 20 determines a switching path of an optical packet based on the optical packet header, switches the optical packet to the determined path, and outputs the switched optical packet to the WDM network 30 or the optical packet receiver 40 through a port.

The WDM network 30 connects the optical packet transmitter 10, the optical packet switching apparatus 20, and the optical packet receiver 40 to another node device in the WDM network 30. The WDM network 30 transfers an optical packet output from node devices other than the optical packet switching apparatus 20 to the optical packet switching apparatus 20 and transfers an optical packet output from the optical packet switching apparatus 20 to other node devices.

The optical packet receiver 40 is a node device that receives an optical packet and converts the received optical packet to an IP packet. Upon conversion of an optical packet to an IP packet, the optical packet receiver 40 performs O/E conversion on the optical packet that is an optical signal, thereby obtaining an electrical signal. The optical packet receiver 40 determines data based on waveforms of electrical signals obtained by converting an optical packet. For example, the optical packet receiver 40 determines data is “1” when the waveform of an electrical signal is larger than a predetermined area and determines data is “0” when the waveform of an electrical signal is smaller than the predetermined area.

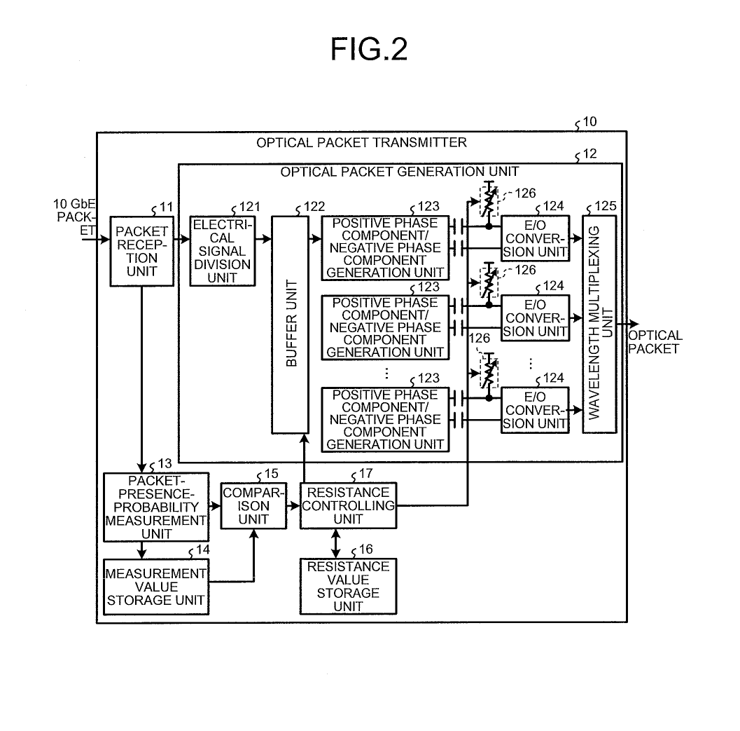

Next, the configuration of the optical packet transmitter 10 illustrated in FIG. 1 will be described. FIG. 2 is a functional block diagram illustrating the configuration of the optical packet transmitter according to the present embodiment. The optical packet transmitter 10 according to the present embodiment includes a packet reception unit 11, an optical packet generation unit 12, a packet-presence-probability measurement unit 13, a measurement value storage unit 14, a comparison unit 15, a resistance value storage unit 16 and a resistance controlling unit 17.

The packet reception unit 11 receives an IP packet that is an optical signal input through, for example, 10G Ethernet, converts the received IP packet to an electrical signal, and outputs the electrical signal after conversion to an electrical signal division unit 121 of the optical packet generation unit 12. An IP packet is an example of the input packet.

The packet reception unit 11 detects a packet length and information of an IFG included in the received IP packet. An IFG is an Inter-Frame Gap that is a time period between an IP packet and another IP packet where no IP packet is present. The packet reception unit 11 also extracts information of a destination IP address included in the received IP packet. The packet reception unit 11 then outputs the packet length and the information of the IFG to the packet-presence-probability measurement unit 13 and outputs the information of the destination IP address to the electrical signal division unit 121.

The optical packet generation unit 12 includes the electrical signal division unit 121, a buffer unit 122, a plurality of positive phase component/negative phase component generation units 123, a plurality of E/O conversion units 124, a wavelength multiplexing unit 125, and a plurality of variable resistor units 126.

The electrical signal division unit 121 accepts input of the electrical signal obtained by converting an IP packet (hereinafter, simply referred to as “electrical signal”) from the packet reception unit 11. The electrical signal division unit 121 divides the electrical signal. The electrical signal division unit 121 outputs electrical signals obtained by the division to the buffer unit 122. The electrical signal division unit 121 adds, as headers, the destination IP address to the heads of the electrical signals obtained by the division.

The buffer unit 122 accepts input of the electrical signals from the electrical signal division unit 121. The buffer unit 122 temporarily holds electrical signals for each of predetermined read addresses. The buffer unit 122 continues the temporarily holding of the electrical signals until the buffer unit 122 accepts an electrical-signal read permission signal to be described below from the resistance controlling unit 17. That is, the buffer unit 122 prohibits each of the positive phase component/negative phase component generation units 123 from reading some of the electrical signals without accepting an electrical-signal read permission signal. When the buffer unit 122 accepts an electrical-signal read permission signal from the resistance controlling unit 17, the buffer unit 122 releases the temporary holding of the electrical signals and permits each of the positive phase component/negative phase component generation units 123 to read the electrical signals. The buffer unit 122 is an example of the holding unit.

Each of the positive phase component/negative phase component generation units 123 reads an electrical signal that is held in the buffer unit 122 for a read address corresponding to the positive phase component/negative phase component generation unit 123, and generates a positive phase component and a negative phase component from the read electrical signal. For example, each of the positive phase component/negative phase component generation units 123 convert parallel data of 600 MHz×16 bit, which is an electrical signal, to serial data of 10 Gbps, thereby generating a positive phase component and a negative phase component from the electrical signal. The positive phase component/negative phase component generation units 123 are also called Parallel/Serial (P/S) converters. A positive phase component and a negative phase component are also called a Positive signal and a Negative signal respectively. Each of the positive phase component/negative phase component generation units 123 outputs the generated positive phase component and negative phase component to each of the E/O conversion units 124. Each of the positive phase component/negative phase component generation units 123 is an example of the generation unit.

Each of the E/O conversion units 124 accepts input of a positive phase component and a negative phase component from each of the positive phase component/negative phase component generation units 123. Each of the E/O conversion units 124 and each of the positive phase component/negative phase component generation units 123 are coupled by AC coupling that allows a positive phase component and a negative phase component to be input to each of the E/O conversion units 124. Each of the E/O conversion units 124 converts an electrical signal to an optical signal having a waveform corresponding to a potential difference between the positive phase component and the negative phase component by using the potential difference of the positive/negative phase components. Note that a unique wavelength is assigned to each of the E/O conversion units 124. Thus, wavelengths of optical signals output from the respective E/O conversion units 124 are different from each other. The respective E/O conversion units 124 output optical signals having wavelengths that are different from each other to the wavelength multiplexing unit 125. Each of the E/O conversion units 124 is an example of the electrical/optical conversion unit.

The wavelength multiplexing unit 125 accepts input of optical signals having wavelengths that are different from each other from the respective E/O conversion units 124. The wavelength multiplexing unit 125 performs wavelength-multiplexing on the optical signals to obtain an optical packet and outputs the optical packet to the optical packet switching apparatus 20 through a port.

Each of the variable resistor units 126 is arranged at the pre-stage of each of the E/O conversion units 124. More specifically, each of the variable resistor units 126 is arranged on a transmission line that allows input of a positive phase component to each of the E/O conversion units 124. Each of the variable resistor units 126 provides, to a positive phase component, a resistor that varies the midpoint of the potential of a positive phase component to be input to each of the E/O conversion units 124. A value of the resistor provided to a positive phase component by the variable resistor unit 126 is called a “resistance value of the variable resistor unit 126” below when it's suitable. The smaller the resistance value of each of the variable resistor units 126 is, the smaller the midpoint of the potential of a positive phase component input to each of the E/O conversion units 124 becomes. Conversely, the larger the resistance value of each of the variable resistor units 126 is, the larger the midpoint of the potential of a positive phase component input to each of the E/O conversion units 124 becomes. The resistance value of the variable resistor units 126 is changed based on control of the resistance controlling unit 17. The resistance value control processing for changing the resistance value of the variable resistor units 126 will be described in detail below.

The packet-presence-probability measurement unit 13 measures a ratio of a presence period to the sum of the presence period and a non-presence period (hereinafter referred to as a “packet presence probability”). The presence period is a period where IP packets are present, and the non-presence period is a period other than the presence period. For example, the presence period may correspond to a packet length of an IP packet, and the non-presence period may correspond to an IFG, which is a period between an IP packet and another IP packet where no IP packet is present. More specifically, the packet-presence-probability measurement unit 13 accepts input of a packet length and an IFG from the packet reception unit 11. The packet-presence-probability measurement unit 13 then calculates packet length/(packet length+IFG), thereby measuring a packet presence probability. The packet presence probability having been measured by the packet-presence-probability measurement unit 13 this time is referred to as “a packet presence probability of this time” when it's suitable. The packet presence probability will be described in detail below. The packet-presence-probability measurement unit 13 is an example of the measurement unit.

In addition, the packet-presence-probability measurement unit 13 outputs the packet presence probability of this time to the comparison unit 15 and stores the packet presence probability of this time in the measurement value storage unit 14.

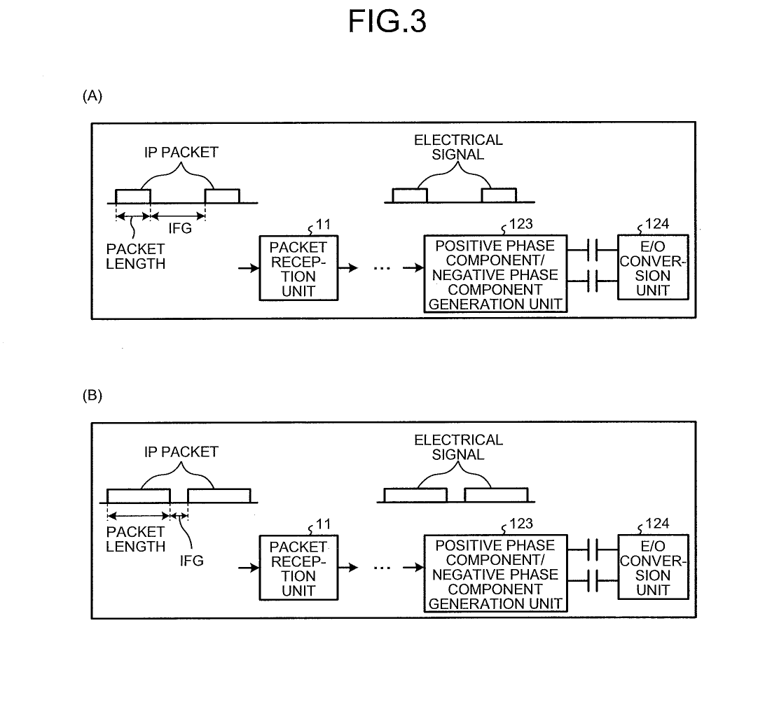

The packet presence probability is now described with reference to FIG. 3. FIG. 3 is a drawing for describing the packet presence probability. FIG. 3 illustrates two cases A and B where the packet presence probabilities are different. In the case A in FIG. 3, the packet presence probability is lower than that in the case B. Specifically, in the case A, the packet length of each of IP packets to be input to the packet reception unit 11 is shorter than that in the case B, and the IFG between the IP packets is longer than that of the case B.

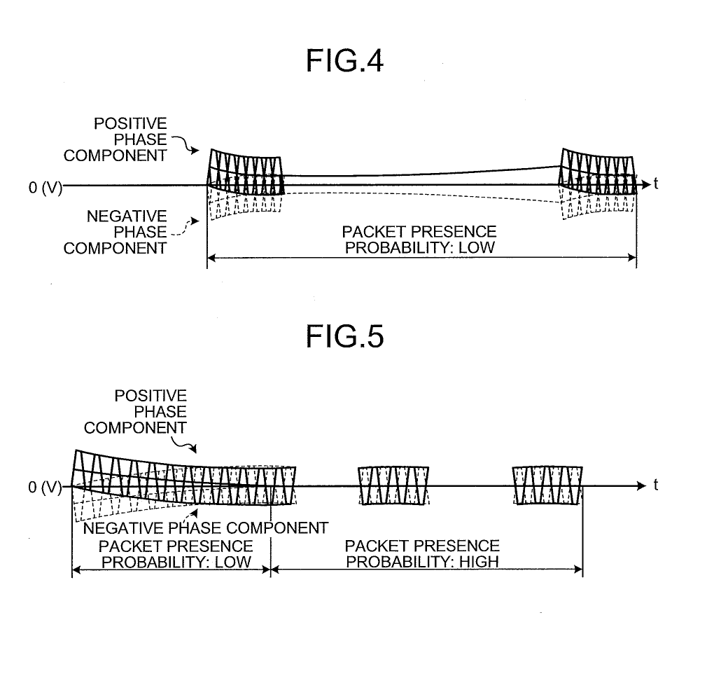

In the case A where the packet presence probability is relatively low, a period where electrical signals are not present becomes longer comparing to the case B, the electrical signals being input to the positive phase component/negative phase component generation units 123 that is positioned on the later side of the packet reception unit 11. In a period where electrical signals are present, impedance of a capacitor of the AC coupling that couples each of the positive phase component/negative phase component generation units 123 and each of the E/O conversion units 124 becomes near zero, and the midpoints of the potential of positive phase components match the midpoints of the potential of a negative phase components. In other words, in a period corresponding to a packet length, the midpoints of the potential of positive phase components match the midpoints of the potential of negative phase components. On the other hand, in a period where no electrical signal is present, impedance of a capacitor of the AC coupling that couples each of the positive phase component/negative phase component generation units 123 and each of the E/O conversion units 124 becomes infinitely large and the midpoints of the potential of positive phase components and a negative phase components to be input to the E/O conversion units 124 are apart in opposite directions. In other words, in a period corresponding to an IFG, the midpoints of the potential of positive phase components and the midpoints of the potential of negative phase components are apart in opposite directions, the positive/negative phase components being input to the E/O conversion units 124. The relationship between the packet presence probability and behavior of a positive phase component and a negative phase component will be described with reference to FIGS. 4 to 6.

FIG. 4 is a drawing for describing the relationship between the packet presence probability and behavior of a positive phase component and a negative phase component (part 1). FIG. 4 illustrates time variation of a positive phase component and a negative phase component input to the E/O conversion units 124 when the packet presence probability is relatively low. As illustrated in FIG. 4, when a state where the packet presence probability is relatively low continues, the midpoint of the potential of the positive phase component and the midpoint of the potential of the negative phase component apart in opposite directions.

FIG. 5 is a drawing for describing the relationship between the packet presence probability and behavior of a positive phase component and a negative phase component (part 2). FIG. 5 illustrates time variation of a positive phase component and a negative phase component input to the E/O conversion units 124 when the packet presence probability transits from a relatively low value to a relatively high value. As illustrated in FIG. 5, when the packet presence probability transits from a relatively low value to a relatively high value, the midpoint of the potential of the positive phase component and the midpoint of the potential of the negative phase component get closer to each other and become the same value.

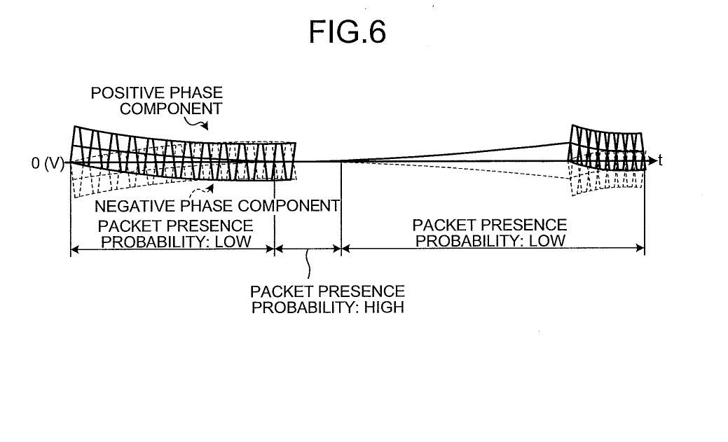

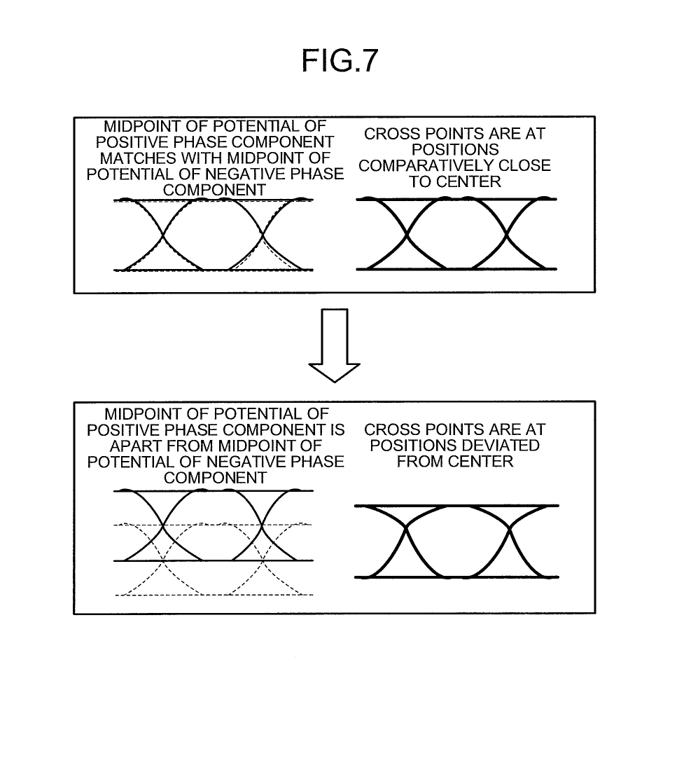

FIG. 6 is a drawing for describing the relationship between the packet presence probability and behavior of a positive phase component and a negative phase component (part 3). FIG. 6 illustrates time variation of a positive phase component and a negative phase component input to the E/O conversion units 124 when the packet presence probability transits from a relatively low value to a relatively high value and then transits to a relatively low value. As illustrated in FIG. 6, when the packet presence probability transits from a relatively low value to a relatively high value and then transits to a relatively value, the positive phase component and the negative phase component behave as follows. That is, the midpoint of the potential of the positive phase component and the midpoint of the potential of the negative phase component get closer to each other and become the same value. After that, the midpoint of the potential of the positive phase component and the midpoint of the potential of the negative phase component are apart in opposite directions again associated with the packet presence probability getting lower. A problem caused when the midpoint of the potential of a positive phase component and the midpoint of the potential of the negative phase component being input to the E/O conversion units 124 apart in opposite directions will be described with reference to FIG. 7.

FIG. 7 illustrates relationship between an eye pattern of electrical signals input to an E/O conversion unit and an eye pattern of optical signals output from the E/O conversion unit. In the upper part and the lower part of FIG. 7, an eye pattern on the left is an eye pattern of electrical signals to be input to the E/O conversion units 124 and an eye pattern on the right is an eye pattern of optical signals output from the E/O conversion units 124.

When the midpoint of the potential of a positive phase component input to the E/O conversion units 124 matches the midpoint of the potential of a negative phase component as illustrated by the eye pattern on the left of the upper part of FIG. 7, an eye pattern of optical signals output from the E/O conversion units 124 has an excellent waveform. Specifically, the eye pattern of the optical signal output from the E/O conversion units 124 has cross points at positions comparatively close to the center as illustrated by the eye pattern on the right of the upper part of FIG. 7. Thus, the waveform becomes a so-called an open eye pattern. By using a waveform of an electrical signal that can be obtained by O/E conversion of an optical signal of this type, the optical packet receiver 40 can perform data determination processing highly precisely.

On the other hand, when the midpoint of the potential of a positive phase component input to the E/O conversion units 124 is apart from the midpoint of the potential of a negative phase component as illustrated by the eye pattern on the left of the lower part of FIG. 7, an eye pattern of an optical signal output from the E/O conversion unit 124 has a deteriorated waveform. Specifically, as illustrated by the eye pattern on the right of the lower part of FIG. 7, the eye pattern of the optical signal output from the E/O conversion units 124 has cross points at positions deviated from the center and is a distorted waveform in comparison to the eye pattern illustrated in FIG. 7. By using a waveform of an electrical signal obtained by O/E conversion of such an optical signal, it is difficult for the optical packet receiver 40 to determine whether the waveform of the electrical signal converted from the optical signal is larger than a predetermined area, and thus the optical packet receiver 40 may determines data wrongly.

FIG. 2 is now described again. The measurement value storage unit 14 stores a packet presence probability measured by the packet-presence-probability measurement unit 13 for the last time. The packet presence probability measured by the packet-presence-probability measurement unit 13 for the last time will be referred to as “a packet presence probability of last time” below. The measurement value storage unit 14 outputs a packet presence probability of last time to the comparison unit 15 every time when the packet-presence-probability measurement unit 13 stores a packet presence probability of this time.

The comparison unit 15 accepts input of a packet presence probability of this time from the packet-presence-probability measurement unit 13. The comparison unit 15 accepts input of a packet presence probability of last time from the measurement value storage unit 14. The comparison unit 15 compares the packet presence probability of this time with the packet presence probability of last time. When the packet presence probability of this time and the packet presence probability of last time do not match, the comparison unit 15 outputs comparison result indicating that the packet presence probability of this time and the packet presence probability of last time do not match to the resistance controlling unit 17. On the other hand, when the packet presence probability of this time and the packet presence probability of last time match, the comparison unit 15 outputs comparison result indicating that the packet presence probability of this time and the packet presence probability of last time match to the resistance controlling unit 17. The condition where the packet presence probability of this time and the packet presence probability of last time match is satisfied when the packet presence probability of this time and the packet presence probability of last time match completely and also when the difference between the packet presence probability of this time and the packet presence probability of last time is smaller than a predetermined threshold. The comparison unit 15 also transfers the packet presence probability of this time with the comparison result to the resistance controlling unit 17.

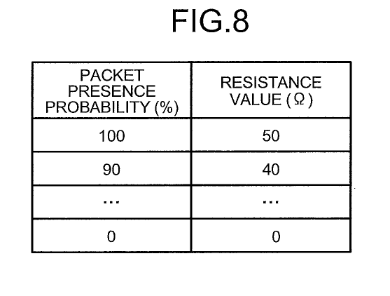

The resistance value storage unit 16 stores a packet presence probability and a resistance value of the variable resistor units 126 in association with each other. FIG. 8 is a diagram illustrating an example of a data structure of a resistance value storage unit in the present embodiment. As illustrated in FIG. 8, the resistance value storage unit 16 stores packet presence probabilities (%) and resistance values (Ω) in association with each other. For example, the resistance value storage unit 16 stores the packet presence probability “100”% and the resistance value “50” Ω of the variable resistor units 126 in association with each other. The resistance value storage unit 16 also stores the packet presence probability “90”% and the resistance value “40” Ω of the variable resistor units 126 in association with each other. The resistance value storage unit 16 also stores the packet presence probability “0”% and resistance value “0” Ω of the variable resistor units 126 in association with each other. In the resistance value storage unit 16 of the present embodiment, the lower the packet presence probability becomes, the smaller the resistance value of the variable resistor units 126 becomes as illustrated in FIG. 8. In other words, the resistance value storage unit 16 stores resistance value of the variable resistor units 126 that varies the midpoint of the potential of a positive phase component smaller as the midpoint of the potential of the positive phase component input to each of the E/O conversion units 124 and the midpoint of the potential of a negative phase component get farther apart in opposite directions.

The resistance controlling unit 17 controls the resistance value of the variable resistor units 126 based on the packet presence probability measured by the packet-presence-probability measurement unit 13 in such a manner that the midpoint of the potential of a positive phase component and the midpoint of the potential of a negative phase component, which would be apart in opposite directions in non-presence periods, get closer to each other. Specifically, the resistance controlling unit 17 accepts input of the comparison result and the packet presence probability of this time from the comparison unit 15. When the comparison result indicates that the packet presence probability of this time and the packet presence probability of last time do not match, the resistance controlling unit 17 acquires, from the resistance value storage unit 16, the resistance value of the variable resistor units 126 corresponding to the packet presence probability of this time. The resistance controlling unit 17 then controls to change the resistance value of the variable resistor units 126 closer to the acquired resistance value. Specifically, the resistance controlling unit 17 controls to change the resistance value of the variable resistor units 126 to a smaller value as the packet presence probability gets lower. On the other hand, the resistance controlling unit 17 stops controlling the resistance value of the variable resistor units 126 when the comparison result indicates that the packet presence probability of this time and the packet presence probability of last time match. The resistance controlling unit 17 is an example of the control unit.

The resistance controlling unit 17 also reports, to the buffer unit 122, an electrical-signal read permission signal for permitting each of the positive phase component/negative phase component generation units 123 to read an electrical signal after the resistance controlling unit 17 completes the control of the variable resistor units 126.

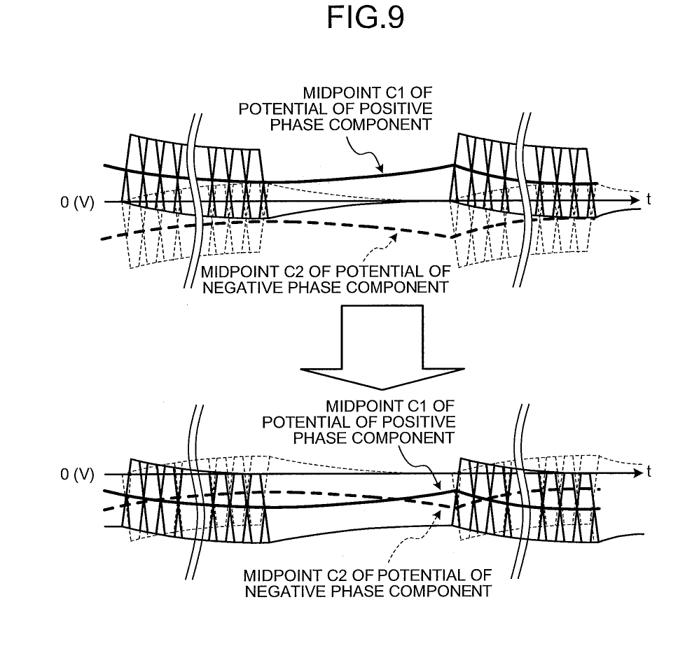

Here, the resistance-value control processing for changing the resistance value of the variable resistor units 126 is described using an example of FIG. 9. FIG. 9 is a diagram for describing the resistance-value control processing for changing the resistance values of the variable resistor unit. The upper part of FIG. 9 illustrates a state where the midpoint C1 of the potential of a positive phase component and the midpoint C2 of the potential of a negative phase component input to the E/O conversion units 124 are apart in opposite directions associated with the packet presence probability getting lower. In the state illustrated in the upper part of FIG. 9, the resistance controlling unit 17 controls to change the resistance value of the variable resistor units 126 as the packet presence probability gets lower. Thus, the midpoint C1 of the potential of the positive phase component input to the E/O conversion units 124 becomes closer to the midpoint C2 of the potential of the negative phase component and finally overlaps with the midpoint C2 of the potential of the negative phase component as illustrated in the lower part of FIG. 9. As a result, the eye pattern of an optical signal output from the E/O conversion units 124 becomes an eye pattern of an excellent waveform as illustrated in the upper part of FIG. 7. That is, it is possible to improve a signal waveform that would be deteriorated due to presence/non-presence of input packets.

The above-described packet-presence-probability measurement unit 13, the comparison unit 15, the resistance controlling unit 17, and the like are realized by, for example, a Central Processing Unit (CPU) and a program that is analyzed and executed by the CPU. Alternatively, the packet-presence-probability measurement unit 13, the comparison unit 15, the resistance controlling unit 17, and the like may be realized by using a Field Programmable Gate Array (FPGA). The above-described measurement value storage unit 14, the resistance value storage unit 16, and the like are realized by using, for example, a Random Access Memory (RAM), a Read Only Memory (ROM), a Flash Memory, a hard disk, an optical disk, and the like.

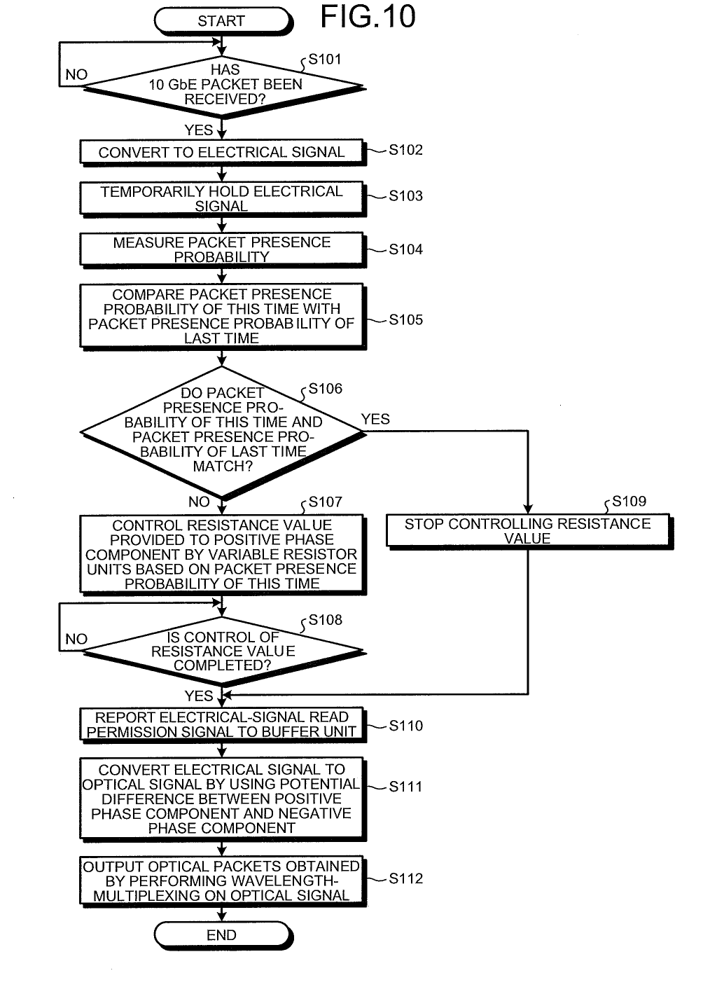

Next, a process of the optical packet transmitter 10 according to the present embodiment will be described with reference to FIG. 10. FIG. 10 is a flowchart illustrating a process of the optical packet transmitter according to the present embodiment.

As illustrated in FIG. 10, the packet reception unit 11 of the optical packet transmitter 10 waits when the packet reception unit 11 has not yet received an IP packet from, for example, 10G Ethernet (step S101; No). On the other hand, when the packet reception unit 11 receives an IP packet (step S101; Yes), the packet reception unit 11 converts the received IP packet to an electrical signal and outputs the electrical signal after conversion to the electrical signal division unit 121 (step S102). The packet reception unit 11 also detects a packet length and information of an IFG included in the received IP packet, and outputs the detected packet length and information of the IFG to the packet-presence-probability measurement unit 13.

The electrical signal division unit 121 divides an electrical signal and outputs the divided electrical signal to the buffer unit 122. The buffer unit 122 temporarily holds the electrical signals for each of predetermined read addresses (step S103).

The packet-presence-probability measurement unit 13 measures a packet presence probability (step S104). For example, the packet-presence-probability measurement unit 13 may measure the packet presence probability by calculating packet length/(packet length+IFG). The packet-presence-probability measurement unit 13 outputs the packet presence probability of this time to the comparison unit 15 and stores the packet presence probability of this time in the measurement value storage unit 14. Since the packet presence probability of this time is stored, the measurement value storage unit 14 outputs the packet presence probability of last time to the comparison unit 15.

The comparison unit 15 compares the packet presence probability of this time with the packet presence probability of last time (step S105). The comparison unit 15 transfers the packet presence probability of this time along with the comparison result to the resistance controlling unit 17.

When the packet presence probability of this time and the packet presence probability of last time don't match (step S106; No), the resistance controlling unit 17 performs the following processing. That is, the resistance controlling unit 17 controls the resistance value of the variable resistor units 126 based on the packet presence probability of this time in such a manner that the midpoint of the potential of a positive phase component and the midpoint of the potential of a negative phase component, which would be apart in opposite directions in non-presence periods, get closer to each other (step S107).

When the control of the resistance value is not completed (step S108; No), the resistance controlling unit 17 waits.

On the other hand, when the packet presence probability of this time and the packet presence probability of last time match (step S106; Yes), the resistance controlling unit 17 stops controlling the resistance value (step S109) and proceeds the processing to step S110.

The resistance controlling unit 17 performs the following processing after completing the control of the resistance value (step S108; Yes) or after stopping the control of the resistance value (step S109). That is, the resistance controlling unit 17 reports, to the buffer unit 122, an electrical-signal read permission signal for permitting each of the positive phase component/negative phase component generation units 123 to read an electrical signal (step S110).

When the buffer unit 122 accepts the electrical-signal read permission signal from the resistance controlling unit 17, the buffer unit 122 releases the temporary holding of the electrical signals and permits the respective positive phase component/negative phase component generation units 123 to read the electrical signals. Each of the positive phase component/negative phase component generation units 123 reads an electrical signal that is held in the buffer unit 122 for an read address corresponding to the positive phase component/negative phase component generation unit 123, generates a positive phase component and a negative phase component from the read electrical signal, and outputs the generated positive phase component and negative phase component to each of the E/O conversion units 124.

Each of the E/O conversion units 124 then converts the electrical signal to an optical signal having a waveform corresponding to a potential difference between the positive phase component and the negative phase component (step S111).

The wavelength multiplexing unit 125 performs wavelength-multiplexing on the optical signal to obtain an optical packet and outputs the optical packets to the optical packet switching apparatus 20 through a port (step S112).

As has been described, the optical packet transmitter 10 measures a packet presence probability and controls the resistance value of the variable resistor units 126 based on the measured packet conversion rate in such a manner that the midpoint of the potential of a positive phase component and the midpoint of the potential of a negative phase component input to the E/O conversion units 124 get closer to each other. Therefore, the optical packet transmitter 10 can control the E/O conversion units 124 to output optical signals having an excellent waveform of a so-called open eye pattern. As a result, it is possible to improve a signal waveform that would be deteriorated due to presence/non-presence of input packets.

In addition, the optical packet transmitter 10 according to the present embodiment compares a packet conversion rate measured this time with a packet conversion rate measured last time. The optical packet transmitter 10 then stops controlling the resistance value of the variable resistor units 126 when the packet presence probability measured this time and the packet presence probability measured last time match as a result of the comparison. Therefore, in a case where a packet presence probability does not vary from the time when the resistance value of the variable resistor units 126 was measured last time by the time to measure the value this time, it is possible to prevent wasteful control of the resistance value of the variable resistor units 126. As a result, processing load increase can be suppressed, and a signal waveform that would be deteriorated due to presence/non-presence of input packets can be improved.

Further, the optical packet transmitter 10 according to the present embodiment reports an electrical-signal read permission signal to the buffer unit 122 after completing the control of the resistance value of the variable resistor units 126. Therefore, it is possible to prevent a positive phase component and a negative phase component having the midpoints of the potential being apart in opposite directions from being input to the E/O conversion units 124 under the condition where the control of the resistance value of the variable resistor units 126 is not completed.

In the embodiment described above, there has been described an example where the optical packet transmitter 10 controls the resistance value of the variable resistor units 126, which is provided to a positive phase component, based on a packet conversion rate in such a manner that the midpoint of the potential of the positive phase component and the midpoint of the potential of a negative phase component input to the E/O conversion units 124 get closer to each other. However, the disclosed technique is not limited to the example. For example, the optical packet transmitter 10 may control the resistance value provided to a negative phase component based on a packet conversion rate. In this case, the variable resistor unit 126 is arranged on a transmission line that allows input of a negative phase component to each of the E/O conversion units 124 to provide, to a negative component, a resistor that varies the midpoint of the potential of the negative phase component to be input to the each E/O conversion units 124. In addition, the resistance controlling unit 17 controls to change the resistance value of the variable resistor units 126 to a larger value as the packet presence probability gets lower. Thus, the midpoint of the potential of a negative phase component input to the E/O conversion units 124 becomes closer to the midpoint of the potential of a positive phase component and finally overlaps with the midpoint of the potential of the positive phase component. As a result, an eye pattern of optical signals output from each of the E/O conversion units 124 becomes an eye pattern of an excellent waveform as illustrated in the upper part of FIG. 7. That is, it is possible to improve a signal waveform that would be deteriorated due to presence/non-presence of input packets.

An aspect of the optical communication apparatus disclosed by the present application has an effect of improving a signal waveform that would be deteriorated due to presence/non-presence of input packets.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical communication apparatus comprising:
a variable resistor unit that is arranged at a pre-stage of an electrical/optical conversion unit, which converts an electrical signal obtained by converting an input packet to an optical signal having a waveform corresponding to a potential difference between a positive phase component and a negative phase component of the electrical signal by using the potential difference, and that provides, to the positive phase component or the negative phase component, a resistor that varies a midpoint of potential of the positive phase component or the negative phase component to be input to the electrical/optical conversion unit;
a measurement unit that measures a ratio of a presence period, which is a period where the input packet is present, to a sum of the presence period and a non-presence period, which is a period other than the presence period; and
a control unit that controls a value of the resistor provided by the variable resistor unit based on the ratio measured by the measurement unit in such a manner that the midpoint of the potential of the positive phase component and the midpoint of the potential of the negative phase component, which would be apart in opposite directions in the non-presence period, get closer to each other.

2. The optical communication apparatus according to claim 1 further comprising
a comparison unit that compares the ratio measured this time and the ratio measured last time by the measurement unit, wherein
the control unit stops controlling the resistance value when the ratio measured this time and the ratio measured last time by the measurement unit match as a result of the comparison by the comparison unit.

3. The optical communication apparatus according to claim 1 further comprising:
a holding unit that temporarily holds the electrical signal obtained by converting the input packet; and
a generation unit that reads the electrical signal held in the holding unit, generates the positive phase component and the negative phase component from the read electrical signal, and outputs the generated positive phase component and negative phase component to the electrical/optical conversion unit, wherein
the control unit reports, after completing the control of the resistance value, a signal for permitting the generation unit to read the electrical signal to the holding unit.

4. A control method of an optical communication apparatus, the method comprising:
measuring a ratio of a presence period, which is a period where an input packet is present, to a sum of the presence period and a non-presence period, which is a period other than the presence period; and
controlling a resistance value of a variable resistor unit that is arranged at a pre-stage of an electrical/optical conversion unit, which converts the electrical signal to an optical signal having a waveform corresponding to a potential difference between a positive phase component and a negative phase component of an electrical signal obtained by converting the input packet by using the potential difference, and that provides, to the positive phase component or the negative phase component, a resistor that varies a midpoint of potential of the positive phase component or the negative phase component to be input to the electrical/optical conversion unit based on the measured ratio in such a manner that the midpoint of the potential of the positive phase component and the midpoint of the potential of the negative phase component, which would be apart in opposite directions in the non-presence period, get closer to each other.
